(19) United States
(12) Patent Application Publication
(10) Pub. No.: US 2024/0429597 A1
(43) Pub. Date: Dec. 26, 2024

(54) ANTENNA DEVICE

(71) Applicant: YOKOWO CO., LTD., Kita-ku, Tokyo (JP)

(72) Inventors: Daisuke NAKAMURA, Gunma (JP); Seiji GO, Gunma (JP)

(73) Assignee: YOKOWO CO., LTD., Kita-ku, Tokyo (JP)

(21) Appl. No.: 18/274,013

(22) PCT Filed: Jan. 17, 2022
(86) PCT No.: PCT/JP2022/001463

§ 371 Date: Jul. 25, 2023

(30) Foreign Application Priority Data
Jan. 26, 2021 (JP) 2021-010611

(51) Int. Cl. H01Q 1/52

(52) U.S. Cl. CPC H01Q 1/526

(57) ABSTRACT

To provide an antenna device capable of suppressing an adverse effect on antenna characteristics and the like due to noise. The antenna device includes: an antenna element, a circuit board including a circuit portion, a base covering at least a part of the circuit portion and provided with a recessed portion functioning as a shield case, and a contact means for bringing the recessed portion and the circuit board into contact with each other.

### TECHNICAL FIELD

The present invention relates to an antenna device.

### BACKGROUND ART

Patent Literature 1 discloses that a metal shield case that does not adversely affect antenna characteristics due to noise coming from the outside or noise generated from a circuit board is used as an antenna device. In the metal shield case, elastic locking pieces are provided in a protruding manner at a plurality of positions of an outer peripheral portion, and after these elastic locking pieces are snap-fitted into corresponding notches of the circuit board, the elastic locking pieces are soldered to a ground pattern on an upper surface side of the circuit board.

### CITATION LIST

### Patent Literature

Patent Literature 1: JP4323440B

### SUMMARY OF INVENTION

### Technical Problem

However, for example, in a fixing method by performing soldering in this way, heat of a soldering iron may escape due to heat conduction by the metal shield case, and a solder failure may occur or a variation may occur in the amount of solder. When contact between the shield case and the circuit board is insufficient due to such a solder failure or variation in the amount of solder, conduction is lowered. As a result, function of the shield case is not sufficiently achieved, and an adverse effect on the antenna characteristics due to noise may not be sufficiently suppressed.

An object of the present invention is to suppress an adverse effect on antenna characteristics and the like due to noise. Other objects of the present invention will become apparent from the description of the present specification.

### Solution to Problem

An antenna device according to an aspect of the present invention includes: an antenna element, a circuit board including a circuit portion; a base covering at least a part of the circuit portion and provided with a recessed portion functioning as a shield case, and a contact means for bringing the recessed portion and the circuit board into contact with each other.

According to the aspect of the present invention, by bringing the recessed portion functioning as the shield case and the circuit board into contact with each other by the contact portion, conduction is not lowered, function of the shield case can be sufficiently exhibited, and an adverse effect on antenna characteristics due to noise can be suppressed.

### BRIEF DESCRIPTION OF DRAWINGS

FIG. 1 is an exploded perspective view showing an overall configuration of an antenna device according to a first embodiment of the present invention.

FIG. 2 shows external perspective views of a base of a first example of the antenna device according to the first embodiment of the present invention, in which (a) of FIG. 2 shows the base in which a recessed portion functioning as a shield case is integrated, and (b) of FIG. 2 is a cross-sectional side view taken along a line IIb-IIb when the recessed portion of the base of (a) of FIG. 2 and a circuit board are fixed to each other.

FIG. 3 shows external perspective views of a base of a second example of the antenna device according to the first embodiment of the present invention, in which (a) of FIG. 3 shows the base in which a recessed portion functioning as a shield case is integrated, and (b) of FIG. 3 is a cross-sectional side view taken along a line IIIb-IIIb when the recessed portion of the base of (a) of FIG. 3 and the circuit board are fixed to each other. (c) of FIG. 3 is a schematic perspective view showing a configuration of a leaf spring.

FIG. 4 shows external perspective views of a base of a third example of the antenna device according to the first embodiment of the present invention, in which (a) of FIG. 4 shows the base in which a recessed portion functioning as a shield case is integrated, and (b) of FIG. 4 is a cross-sectional side view taken along a line IVb-IVb when the base of (a) of FIG. 4 and the circuit board are fixed to each other.

FIG. 5 shows external perspective views of a base of a fourth example of the antenna device according to the first embodiment of the present invention, in which (a) of FIG. 5 shows the base in which a recessed portion functioning as a shield case is integrated, and (b) of FIG. 5 is a cross-sectional side view taken along a line Vb-Vb when the base of (a) of FIG. 5 and the circuit board are fixed to each other.

(a) of FIG. 6 is an exploded perspective view showing an overall configuration of an antenna device according to a second embodiment of the present invention. (b) of FIG. 6 is a cross-sectional side view taken along a line VIb-VIb when the base of (a) of FIG. 6 and a circuit board are fixed to each other.

### DESCRIPTION OF EMBODIMENTS

Hereinafter, embodiments of the present invention will be described in detail with reference to the accompanying drawings. The embodiments described below are not all embodiments according to the present disclosure and are merely illustrative.

### First Embodiment

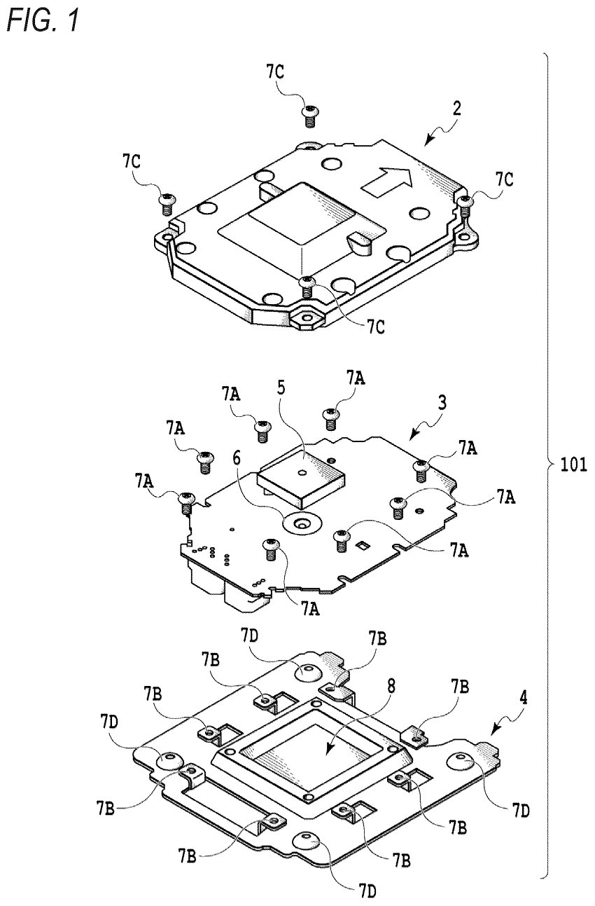

An antenna device according to a first embodiment of the present invention will be described with reference to FIGS. 1 to S.

### (Overall Configuration of Antenna Device)

The antenna device according to the first embodiment of the present invention is mounted on a dashboard or an instrument panel in a vehicle, for example, and relates to a form used for a global navigation satellite system (GNSS) or the like. The application of the present invention is not limited to this form. For example, it is apparent from the following description that use of an antenna is not limited to the GNSS.

FIG. 1 is an exploded perspective view showing a configuration of an antenna unit 101 constituting the antenna device according to the first embodiment of the present invention.

The antenna unit 101 includes a case 2, a circuit board 3, a base 4 having a recessed portion 8 that functions as a shield case to be described later, and a patch antenna 5.

The case 2 is a resin synthetic product made of a radio wave transmissive synthetic resin or the like.

The circuit board 3 has a substantially plane shape, and a conductor pattern (not shown) and a semiconductor component (not shown) are mounted on a lower surface thereof. The conductor pattern and the semiconductor component correspond to a circuit portion of the present invention (hereinafter, the conductor pattern or the semiconductor component will be simply referred to as the circuit portion). The conductor pattern may be mounted on an upper surface of the circuit board 3. The patch antenna 5 is provided as an antenna element on the upper surface of the circuit board 3. The circuit board 3 performs processes such as phase shift and synthesis on a signal received by the patch antenna 5 through the conductor pattern or the semiconductor component, and transmits the signal to an external device such as a navigation device via a coaxial cable (not shown).

The base 4 is a metal component having the recessed portion 8 that functions as the shield case. The patch antenna 5 is, for example, an antenna of a satellite positioning system capable of receiving a signal in a frequency band of the GNSS, and is attached to the circuit board 3 by a double-sided sticker 6.

The recessed portion 8 provided in the base 4 is formed by forming protruding portions by performing drawing processing or the like on a metallic sheet metal. For example, a height of the protruding portions from a bottom surface of the base 4 is set to a height at which the protruding portions are not in contact with the semiconductor component of the circuit board 3. Further, the recessed portion 8 having a recessed shape is formed by forming the protruding portions in a way of surrounding a region where the circuit portion of the circuit board 3 is present. That is, the recessed portion 8 is formed integrally with the base 4. Further, the metal recessed portion 8 having the recessed shape functions as the shield case that covers the circuit portion of the circuit board 3 and is electrically connected to the base 4 by the circuit board 3 being in contact with an entire upper portion 81 of walls of the protruding portions. In this configuration, the recessed portion 8 functioning as the shield case is integrally formed with the base 4, but the recessed portion 8 may be formed separately from the base 4.

The circuit board 3 is fixed to the base 4 by screwing eight screws 7A shown in FIG. 1 into eight screw holes 7B that correspond to the respective screws 7A and are provided in the base 4. The case 2 is fixed to the base 4 by screwing four screws 7C into four screw holes 7D that correspond to the respective screws 7C and are provided in the base 4. In this way, the circuit board 3 is accommodated in an internal space formed by fixing the case 2 to the base 4. As shown in FIG. 1, the eight screw holes 7B of the base 4 to which the screws 7A are screwed when the circuit board 3 is fixed are provided in portions that rise from the bottom surface of the base 4 and are bent in a direction substantially parallel to the bottom surface. A height of the portion rising from the bottom surface of the base 4 from the bottom surface is substantially the same as the height of the protruding portion in the recessed portion 8. The number of screws 7A and the number of screw holes 7B are not limited thereto.

Hereinafter, each example in the first embodiment having a configuration in which the recessed portion 8 functioning as the shield case provided in the base 4 and the circuit board 3 are brought into contact with each other will be described.

### First Example

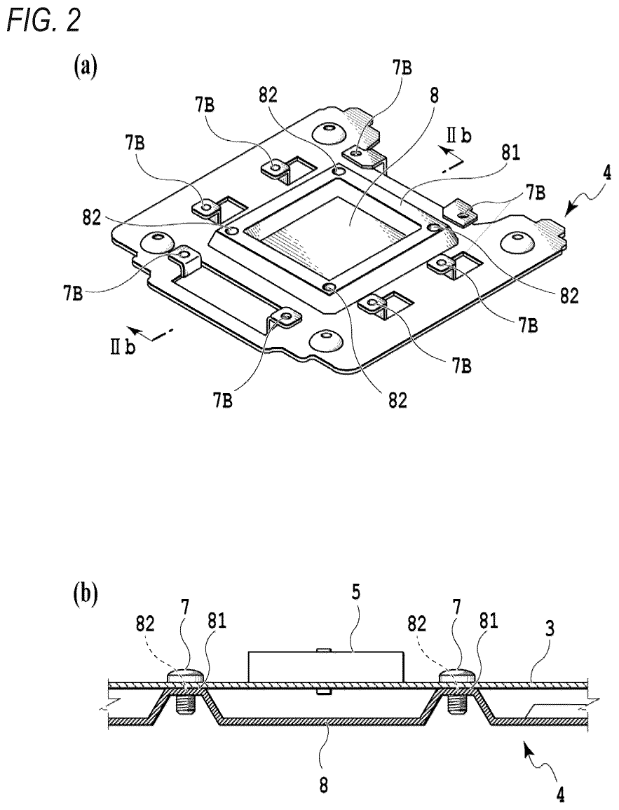

A first example of a configuration in which the recessed portion 8 functioning as the shield case formed integrally with the base 4 and the circuit board 3 are brought into contact with each other will be described with reference to FIG. 2.

(a) of FIG. 2 is a schematic perspective view of the base 4 as the first example of the antenna unit 101 according to the first embodiment of the present invention, and (b) of FIG. 2 is a cross-sectional view taken along a line IIb-IIb in (a) of FIG. 2 when the circuit board 3 and the base 4 are fixed to each other Oblique lines in (b) of FIG. 2 are schematically shown to distinguish between the circuit board 3 (an interval between the oblique lines is wide) and the base 4 (an interval between the oblique lines is narrow).

As shown in (a) of FIG. 2, the recessed portion 8 is provided in a portion covering the circuit portion in the circuit board 3 when the circuit board 3 is fixed to the base 4 in the vicinity of substantially a center of the base 4. The recessed portion 8 is a quadrangle in a plan view, and each side of the quadrangle is formed by a wall of a protruding portion rising from the bottom surface of the base 4. Further, the recessed portion 8 has an inner region surrounded by the walls of the protruding portions of the four sides of the quadrangle and the bottom surface of the base 4. By accommodating the circuit portion on a lower surface side of the circuit board 3 in the inner region of the recessed portion 8, for example, an adverse effect on antenna characteristics and the like due to noise generated from the circuit portion is suppressed.

Specifically, the upper portion 81 of the wall of the protruding portion forming each side of the quadrangle of the recessed portion & is formed as a plane. In particular, this plane is parallel to the bottom surface of the base 4. Further, screw holes 82 are provided in vertex portions of the quadrangle in the upper portion 81 of the walls of the protruding portions in the recessed portion 8. Then, the base 4 having the recessed portion 8 is fixed to the circuit board 3 by screws 7. For example, each of the screw holes 82 may be provided in a substantially central portion of the plane of the upper portion 81 of the wall of each protruding portion instead of the vertex portion, and the screw 7 may be fixed by being screwed into the screw hole 82.

As shown in (b) of FIG. 2, the walls of the protruding portions forming the periphery of the recessed portion & rise so as to be inclined from the bottom surface of the base 4. The entire upper portion 81 of the walls of the protruding portions has a plane shape substantially parallel to the bottom surface of the base 4. When the circuit board 3 is fixed to the base 4, the entire plane of the upper portion 81 of the walls of the protruding portions and a part of a lower surface of the circuit board 3 are in close contact with each other. Further, by screwing the screws 7 into the screw holes 82 provided in the plane of the upper portion 81, a contact state in which a degree of adhesion is increased is achieved. As shown in (b) of FIG. 2, cavities are formed below the upper portion 81 in the protruding portions in the recessed portion 8. When the screws 7 are screwed into the screw holes 82, front ends of the screws 7 are accommodated in the cavities, so that the size of the antenna device itself is not increased.

Accordingly, the upper portion 81 of the walls of the protruding portions in the recessed portion 8 and the circuit board 3 can be brought into contact with each other in a good contact state without a gap therebetween. That is, it is possible to improve the contact state in a contact area, as a required contact area, in which sufficient conductivity capable of suppressing noise is secured. Incidentally, only by forming the protruding portions, warpage and variation occur in the protruding portions due to processing or aged deterioration. Further, since the gap is formed between the upper portion 81 of the walls of the protruding portions in the recessed portion 8 and the lower surface of the circuit board 3, conduction is lowered, and a shielding function of the recessed portion 8 may be deteriorated. On the other hand, in the first example, the upper portion 81 of the wall of the protruding portion constituting each side of the quadrangle in the plan view is a plane, and the screw holes 82 are provided in the plane to strengthen the contact state between the upper portion 81 and the circuit board 3. Therefore, it is possible to suppress the occurrence of warpage and variation due to processing or aged deterioration, and to maintain a state in which a required contact area is secured, such as a state in which no gap is present between the recessed portion 8 and the circuit board 3.

Further, since the screws 7 are used to fasten the base 4 and the circuit board 3, assembly is easy, and product variations and assembly errors can be suppressed. Further, since the recessed portion 8 functioning as the shield case and the base 4 are integrally formed, the number of components can be reduced, and a cost can be reduced. In the present embodiment, the recessed portion 8 is the quadrangle in the plan view, but is not limited thereto, and may be, for example, a circular shape, an elliptical shape, or the like in the plan view.

By covering the circuit portion that generates noise, the recessed portion 8 can suppress an adverse effect on the circuit portion due to noise coming from outside and an adverse effect on the antenna characteristics and the like due to the noise generated from the circuit portion.

### Second Example

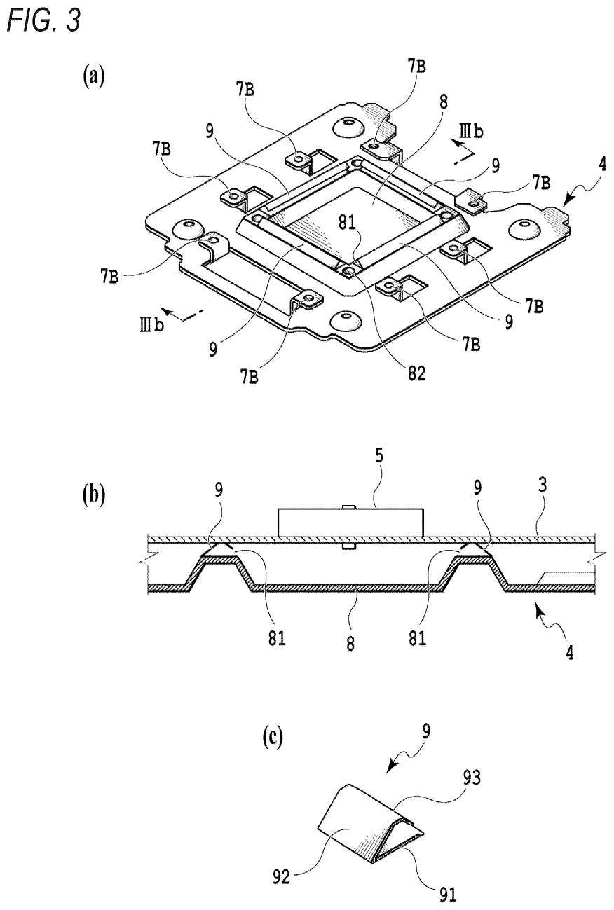

A second example of a configuration in which the recessed portion 8 functioning as the shield case formed integrally with the base 4 and the circuit board 3 are brought into contact with each other will be described with reference to FIG. 3.

The second example relates to a mode in which leaf springs 9 in contact with the circuit board 3 are provided on the upper portion 81 of the walls of the protruding portions in the recessed portion 8 of the first example. Hereinafter, differences from the above-described first example will be mainly described.

(a) of FIG. 3 is a perspective view of the base 4 of the second example, (b) of FIG. 3 is a cross-sectional view taken along a line IIIb-IIIb in (a) of FIG. 3 when the circuit board 3 is fixed to the base 4, and (c) of FIG. 3 is a perspective view of the conductive leaf spring 9 in (a) and (b) of FIG. 3. Oblique lines in (b) of FIG. 3 are schematically shown to distinguish between the circuit board 3 (an interval between the oblique lines is wide) and the base 4 (an interval between the oblique lines is narrow).

As shown in (a) and (b) of FIG. 3, in the second example, the conductive leaf springs 9 are attached to substantially the entire plane of the upper portion 81 of a wall of each protruding portion forming four sides of the quadrangle in a plan view of the recessed portion 8.

As shown in (c) of FIG. 3, the conductive leaf spring 9 includes a fixing portion 91 fixed to the plane of the upper portion 81 of the wall of the protruding portion, an extending portion 92 extending obliquely upward from an end portion of the fixing portion 91, and a bent portion 93 in which an end portion of the extending portion 92 on an opposite side from the fixing portion 91 side is bent. The leaf spring 9 has upward elasticity with respect to the fixing portion 91, and when a top portion of the bent portion 93 is pressed downward from above, a force against the elasticity is exerted. The fixing portion 91 of the leaf spring 9 is fixed to the plane of the upper portion 81 of the wall of the protruding portion in the recessed portion 8 by a conductive double-sided tape or the like. The entire top portion of the bent portion 93 is substantially parallel to the plane of the upper portion 81. A portion of the top portion in contact with (in surface contact with) the circuit board 3 may be a plane, or only an upper portion having a curved surface shape may be in contact with (in line contact with) the circuit board 3.

When the circuit board 3 is fixed to the base 4, the top portion of the bent portion 93 of the leaf spring 9 is in close contact with a part of the lower surface of the circuit board 3. When the circuit board 3 is screwed to the base 4 using the screws 7, the circuit board 3 presses the leaf springs 9 downward. Then, a force against the pressing force is applied to the leaf spring 9, and the top portion of the bent portion 93 and a part of the lower surface of the circuit board 3 are brought into a contact state in which the degree of adhesion is increased.

In the second example, the fixing portion 91 of the conductive leaf spring 9 is fixed to the plane of the upper portion 81 of the protruding portion, and the top portion of the bent portion 93 is brought into contact with the circuit board 3, but the fixing portion 91 of the leaf spring 9 may be fixed to the circuit board 3, and the top portion of the bent portion 93 may be brought into contact with the plane of the upper portion 81 of the wall of the protruding portion. In this case, the leaf spring 9 may fix the fixing portion 91 to the circuit board 3 with a conductive double-sided tape or may be mounted on the circuit board 3 by reflow.

With such a configuration, it is possible to increase the contact area therebetween by the reaction force of the leaf springs 9, and it is possible to obtain higher conductivity between the circuit board 3 and the recessed portion 8 and to suppress an adverse effect on the antenna characteristics and the like due to noise. As described above, by providing the leaf springs 9, it is possible to obtain a required contact area, and thus it is possible to reduce the number of screws for fixing the circuit board 3 and the base 4. That is, the number of screws can be determined within a range in which the required contact area can be obtained by using the reduced number of screws and the leaf springs 9. As a result, it is possible to reduce the cost by reducing the number of components and suppress product variations and assembly errors during assembly.

### Third Example

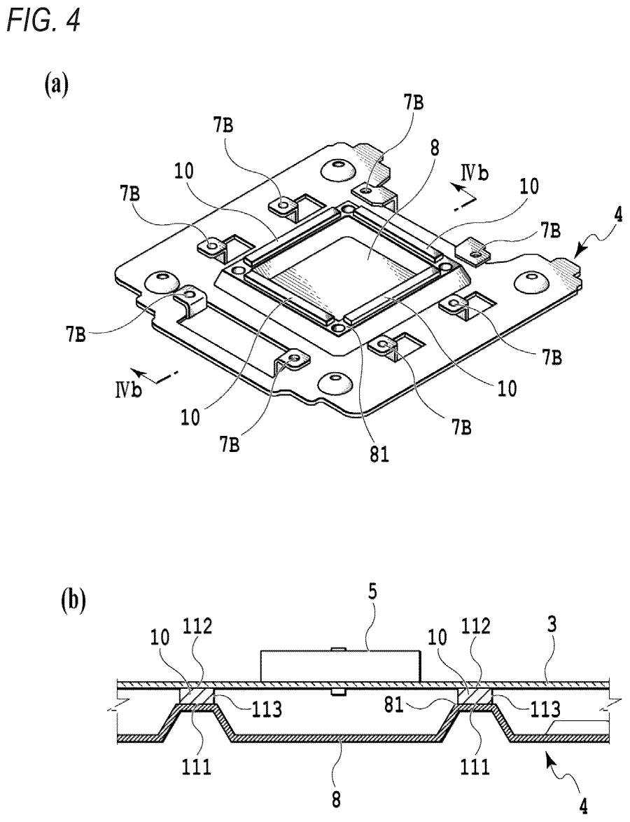

A third example of the configuration in which the recessed portion 8 functioning as the shield case formed integrally with the base 4 and the circuit board 3 are brought into contact with each other will be described with reference to FIG. 4.

The third example relates to a form in which conductive cushions 10 in contact with the circuit board 3 are provided on the plane of the upper portion 81 of the walls of the protruding portions in the recessed portion 8 of the first example. Hereinafter, differences from the above-described first example will be mainly described.

(a) of FIG. 4 is a schematic perspective view of the base 4 of the third example, and

(b) of FIG. 4 is a cross-sectional view taken along a line IVb-IVb in (a) of FIG. 4 when the circuit board 3 is fixed to the base 4. Oblique lines in (b) of FIG. 4 are schematically shown to distinguish between the conductive cushions 10 (an interval between the oblique lines is the widest), the circuit board 3 (an interval between the oblique lines is narrower than the interval in the conductive cushions 10 and wider than the interval in the base 4), and the base 4 (an interval between the oblique lines is the narrowest).

As shown in (a) and (b) of FIG. 4, in the third example, the conductive cushion 10 having elasticity is attached to substantially the entire plane of the upper portion 81 of the wall of each protruding portion in the recessed portion 8.

As shown in (b) of FIG. 4, the conductive cushion 10 includes a fixing portion 111 fixed to the plane of the upper portion 81 of the wall of the protruding portion, an upper surface 112 in contact with the circuit board 3, and a side portion 113 extending between the fixing portions 111. The conductive cushion 10) configured as described above has upward elasticity with respect to the upper surface 112 and downward elasticity with respect to the fixing portion 111, and when the entire conductive cushion 10 is pressed downward from above, a force against the elasticity is exerted. The fixing portion 111 of the conductive cushion 10 is fixed to the plane of the upper portion 81 of the wall of the protruding portion in the recessed portion 8 by a double-sided tape or the like. Further, the upper surface 112 is configured to be substantially parallel to the plane of the upper portion 81.

When the circuit board 3 is fixed to the base 4, the upper surface 112 of the conductive cushion 10 is in close contact with a part of the lower surface of the circuit board 3. When the circuit board 3 is screwed to the base 4 using the screws 7, the circuit board 3 presses the conductive cushion 10) downward. Then, a force against the pressing force is exerted by the conductive cushion 10, and the upper surface 112 and a part of the lower surface of the circuit board 3 are brought into a contact state in which the degree of adhesion is increased. Accordingly, it is possible to increase the contact area therebetween by the reaction force of the conductive cushion 10, and it is possible to obtain higher conductivity between the circuit board 3 and the recessed portion 8 and suppress an adverse effect on the antenna characteristics and the like due to noise. As described above, by providing the conductive cushion 10, it is possible to obtain a required contact area, and thus it is also possible to reduce the number of screws for fixing the circuit board 3 and the base 4 to each other. That is, the number of screws can be determined within a range in which the required contact area can be obtained by using the reduced number of screws and the conductive cushions 10. As a result, it is possible to reduce the cost by reducing the number of components and suppress product variations and assembly errors during assembly.

### Fourth Example

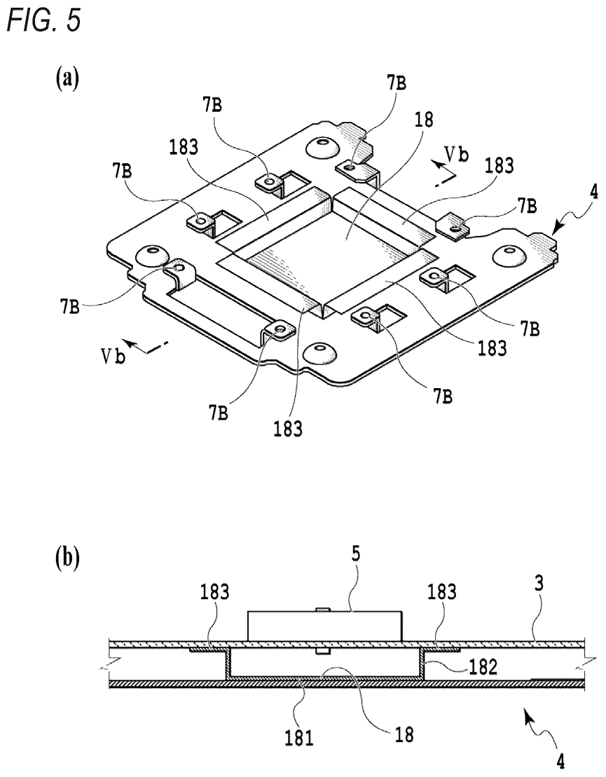

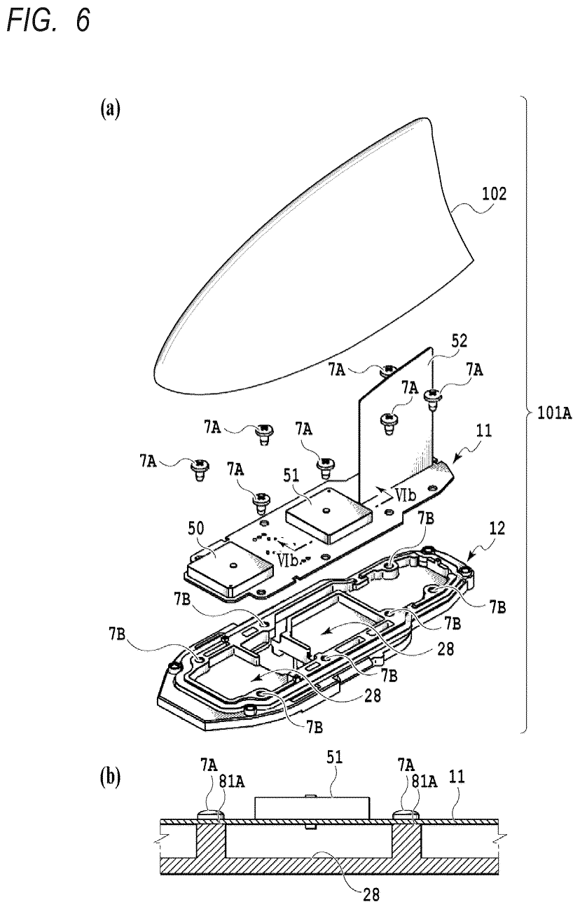

A fourth example of a configuration in which a recessed portion 18 functioning as the shield case formed separately from the base 4 and the circuit board 3 are brought into contact with each other will be described with reference to FIG. 5. The fourth example is different from the recessed portions 8 of the first to third examples described above, and relates to the base 4 having the recessed portion 18 formed separately from the base 4.

(a) of FIG. 5 is a schematic perspective view of the base 4 having the recessed portion 18 of the fourth example, and (b) of FIG. 5 is a cross-sectional view taken along a line Vb-Vb of (a) of FIG. 5 when the circuit board 3 is fixed to the base 4. Oblique lines in (b) of FIG. 5 are schematically shown to distinguish between the circuit board 3 (an interval between the oblique lines is wide), the base 4 (an interval between the oblique lines is narrow), and the recessed portion 18 of the sheet metal therebetween.

As shown in (a) of FIG. 5, the recessed portion 18 of the fourth example is not formed integrally with the base 4, and the recessed portion 18 manufactured as an independent component is joined to the base 4 by welding.

As shown in (b) of FIG. 5, the recessed portion 18 includes a bottom portion 181 in contact with the base 4, a side portion 182 rising in a direction substantially perpendicular to the bottom portion and fixed to the base 4 by welding, and a plane portion 183 extending in a direction substantially perpendicular to the side portion 182 and in contact with the circuit board 3. The recessed portion 18 is a box type that is manufactured by sheet metal processing, and forms the plane portion 183 which is a plane portion for conduction with the circuit board 3 by bending the plane portion 183 at a right angle with respect to the side portion 182. By performing manufacturing in this manner, it is not necessary to perform drawing processing, and a desired shape can be easily obtained only by metallic sheet metal processing.

When the recessed portion 18 configured as described above is fixed to the base 4 by welding, the bottom portion 181 has a large contact area with the base 4, and the plane portion 183 is a plane substantially parallel to the plane of the base 4, so that it is possible to obtain a sufficient contact area with the lower surface of the circuit board 3, to obtain higher conductivity between the circuit board 3 and the recessed portion 18, and to suppress an adverse effect on the antenna characteristics and the like due to noise.

The leaf spring 9 described in the second example and the conductive cushion described in the third example may be attached to the plane portion 183. Thereby, the same effects as those of the second example and the third example can be obtained.

Further, in the fourth example, the recessed portion 18 is joined to the base 4 by welding, but the present invention is not limited thereto, and for example, a recessed accommodation portion or a through hole for accommodating the recessed portion 18 may be provided in the base 4, and the circuit board 3, the recessed portion 18, and the base 4 may be fastened together by screws.

### Second Embodiment

An antenna device according to a second embodiment of the present invention will be described with reference to FIG. 6.

### (Overall Configuration of Antenna Device)

The antenna device according to the second embodiment of the present invention relates to a shark fin type antenna device mounted on a roof of a vehicle. The antenna device is a composite antenna device in which a plurality of antennas are mounted.

(a) of FIG. 6 is an exploded perspective view showing a configuration of an antenna unit 101A constituting the antenna device according to the second embodiment of the present invention.

The antenna unit 101A includes a case 102, a circuit board 11, a base 12 having recessed portions 28 functioning as a shield case to be described later, two patch antennas 50, 51, and a TEL antenna 52.

The case 102 is a shark fin shaped resin synthetic product made of a radio wave transmissive synthetic resin or the like.

The circuit board 11 has a substantially plane shape, and a conductor pattern (not shown) and a semiconductor component (not shown) are mounted on a lower surface thereof.

The conductor pattern and the semiconductor component correspond to a circuit portion of the present invention (hereinafter, the conductor pattern or the semiconductor component will be simply referred to as the circuit portion). The conductor pattern may be mounted on an upper surface of the circuit board 11. Further, the two patch antennas 50, SI and the TEL antenna 52 are provided as antenna elements on the upper surface of the circuit board 11. The circuit board 11 performs processes such as phase shift and synthesis on individual signals received by the patch antennas 50, 51 and the TEL antenna 52 through the conductor pattern or the semiconductor component, and transmits the signals to an external device such as a navigation device via a coaxial cable (not shown).

The base 12 is a metal component having the two recessed portions 28 functioning as the shield case. The patch antenna 50 is a satellite digital audio radio service (SDARS) antenna, and is a satellite digital audio radio service capable of receiving a signal in a frequency band of the SDARS. The patch antenna 51 is a GNSS antenna and is a satellite positioning system capable of receiving a signal in a frequency band of the ONSS. The patch antennas 50, 51 are attached to the circuit board 11 by a sticker or the like. The TEL antenna is attached to the circuit board 11 by, for example, caulking a terminal of a TEL antenna to perform soldering.

Each of the two recessed portions 28 provided in the base 12 is formed by a rib standing from a bottom surface of the base 12 by cutting or the like. For example, a height of the rib from the bottom surface of the base 12 is set to a height at which the rib is not in contact with the semiconductor component of the circuit board 11, and the recessed portions 28 having a concave shape are formed by forming the rib in a way of surrounding a region where the circuit portion of the circuit board 11 is present.

That is, the recessed portions 28 are formed integrally with the base 12. Further, the metal recessed portions 28 cover the circuit portion of the circuit board 11 by the circuit board 11 being in contact with an entire upper portion 81A of the rib, so that the metal recessed portions 28 function as the shield case that is electrically connected to the base 12. In this configuration, the recessed portions 28 functioning as the shield case are integrally formed with the base 12, but these two recessed portions 28 may be formed separately from the base 12, or any one of them may be formed separately.

The circuit board 11 is fixed to the base 12 by screwing seven screws 7A shown in (a) of FIG. 6 into the seven screw holes 7B that correspond to the respective screws 7A and are provided in the base 12. The case 102 is fixed to the base 12 by engaging a locking claw (not shown) with an engaging portion (not shown) provided on the base 12. In this way, the circuit board 11, the patch antennas 50, 51, and the TEL antenna 52 are accommodated in an internal space formed by fixing the case 102 to the base 12. As shown in FIG. 6, five screw holes 7B in the base 12 to which five screws 7A of the seven screws 7A are screwed when the circuit board 11 is fixed to the base 12 are provided in the vicinity of the patch antennas 50, 51. The number of screws 7A and the number of screw holes 7B are not limited thereto.

(Configuration in which Recessed Portions 28 and Circuit Board 11 are in Contact with Each Other)

As shown in (a) of FIG. 6, the two recessed portions 28 are provided in a portion covering the circuit portion in the circuit board 11 when the circuit board 11 is fixed to the base 12 in the vicinity of substantially a center and substantially a front side of the base 12. (b) of FIG. 6 is a cross-sectional view of, of the two recessed portions 28, a recessed portion 28 located below the patch antenna 11. Oblique lines in (b) of FIG. 6 are schematically shown to distinguish between the circuit board 11 (an interval between the oblique lines is wide) and the base 12 (an interval between the oblique lines is narrow). The recessed portion 28 is a quadrangle in a plan view, and has an inner region surrounded by the rib of four sides of the quadrangle and the bottom surface of the base 12 By accommodating the circuit portion on a lower surface side of the circuit board 11 in an inner region of the recessed portion 28, for example, an adverse effect on antenna characteristics and the like due to noise generated from the circuit portion is suppressed.

Specifically, an upper portion 81A of the rib forming each side of a rectangular shape of the recessed portion 28 is formed as a plane. This plane is substantially parallel to the bottom surface of the base 12. When the circuit board 11 is fixed to the base 12, the five screw holes 7B are positioned in the vicinity of an end portion of the rib, and the entire upper plane of the rib and a part of a lower surface of the circuit board 11 are in close contact with each other. Then, the circuit board 11 is screwed to the base 12 having the recessed portions 28 with the screws 7A, thereby achieving a contact state in which a degree of adhesion is increased. Incidentally, similarly to the first example in the first embodiment, screw holes may be provided in the plane of the upper portion 81A of the rib, and the screws may be screwed thereto.

Accordingly, the upper portion of the rib in the recessed portion 28 and the circuit board 11 can be brought into contact with each other in a good contact state without a gap therebetween. That is, it is possible to improve the contact state in a required contact area, that is, a contact area in which sufficient conductivity capable of suppressing an adverse effect on antenna characteristics due to noise is secured.

Further, the base 12 of the second embodiment may be made of a resin subjected to die casting or plating. For example, when the base 12 is made of die casting, the base, which is a metal cutting component in the above-described example, can be manufactured by casting and is more easily manufactured, and the cost can also be reduced. Further, in the case where the base 12 is made of a resin subjected to plating, a shape of the resin before plating can be set to a desired shape at one time by molding the resin by injection molding or the like, and manufacturing is also easy.

As shown in (b) of FIG. 6, when the base 12 is made of a resin subjected to die casting or plating, the protruding portions of the four sides forming the quadrangle in a plan view can be formed more easily.

### SUMMARY

The disclosure of the present specification according to the embodiments described above can be summarized as follows.

According to an aspect of the present disclosure, there is provided an antenna device including an antenna element, a circuit board including a circuit portion, a base covering at least a part of the circuit portion and provided with a recessed portion functioning as a shield case, and a contact means for bringing the recessed portion and the circuit board into contact with each other.

According to this aspect, it is possible to suppress an adverse effect on the circuit portion due to noise coming from outside and an adverse effect on antenna characteristics due to noise generated from the circuit portion.

The contact means may include a screw hole provided in the recessed portion and a screw screwed into the screw hole.

According to this aspect, by screwing the screw into the screw hole provided in the recessed portion, a contact state in which a degree of adhesion is increased can be achieved. A portion of the recessed portion in contact with the circuit board may be a plane substantially parallel to a bottom surface of the base.

According to this aspect, it is possible to suppress occurrence of warpage and variation due to processing or aged deterioration, and to maintain a state in which a required contact area is secured, such as a state in which no gap is present between the recessed portion and the circuit board.

The recessed portion may be integrally formed with the base.

According to this aspect, the number of components can be reduced, and the cost can be reduced.

The contact means may include a leaf spring provided in the recessed portion.

The contact means may include a conductive cushion provided in the recessed portion.

According to this aspect, it is possible to increase the contact area between the recessed portion and the circuit board by a reaction force of the leaf spring or a reaction force of the conductive cushion, and it is possible to obtain higher conductivity between the circuit board and the recessed portion and to suppress an adverse effect due to noise.

The base may be made of a resin subjected to die casting or plating.

According to this aspect, the manufacturing becomes easier and the cost can be reduced.

### REFERENCE SIGNS LIST

2,102 case
3, 11 circuit board
4, 12 base
5 patch antenna
6 double-sided sticker
7, 7A, 7C screw
7B, 7D screw hole
8, 18, 28 recessed portion
9 leaf spring
10 conductive cushion
50 SDARS antenna
51 GNSS antenna
52 TEL antenna
81, 81A upper portion of wall of protruding portion #2 screw hole
91 fixing portion
122 extending portion
93 bent portion
100 antenna device
101, 101A antenna unit
111 fixing portion
112 upper portion
113, 182 side portion
181 bottom portion
183 plane portion

1. An antenna device comprising:
an antenna element;
a circuit board including a circuit portion;
a base covering at least a part of the circuit portion and provided with a recessed portion functioning as a shield case; and
a contact means for bringing the recessed portion and the circuit board into contact with each other.

2. The antenna device according to claim 1,
wherein the contact means includes a screw hole provided in the recessed portion and a screw screwed into the screw hole.

3. The antenna device according to claim 1,
wherein a portion of the recessed portion in contact with the circuit board is a plane substantially parallel to a bottom surface of the base.

4. The antenna device according to claim 1,
wherein the recessed portion is integrally formed with the base.

5. The antenna device according to claim 1,
wherein the contact means includes a leaf spring provided in the recessed portion.

6. The antenna device according to claim 1,
wherein the contact means includes a conductive cushion provided in the recessed portion.

7. The antenna device according to claim 1,
wherein the base is made of a resin subjected to die casting or plating.
